(19) United States
(12) Patent Application Publication
(10) Pub. No.: US 2023/0291008 A1
(43) Pub. Date: Sep. 14, 2023

(54) SOLID ELECTROLYTE CERAMIC AND SOLID-STATE BATTERY

(71) Applicant: Murata Manufacturing Co., Ltd., Nagaokakyo-shi (JP)

(72) Inventors: Yusuke TAKARA, Nagaokakyo-shi (JP); Ryohei TAKANO, Nagaokakyo-shi (JP)

(21) Appl. No.: 18/318,148

(22) Filed: May 16, 2023

Related U.S. Application Data
(63) Continuation of application No. PCT/JP2021/042216, filed on Nov. 17, 2021.

(30) Foreign Application Priority Data
Nov. 17, 2020 (JP) 2020-191138

(51) Int. Cl. H01M 10/0562; H01M 10/0525

(52) U.S. Cl. CPC H01M 10/0562; H01M 10/0525; H01M 2300/0071

(57) ABSTRACT

A solid electrolyte ceramic that has a garnet-type crystal structure, and contains: at least Li, La, and O; and one or more transition metal elements selected from the group consisting of Co, Ni, Mn, and Fe, wherein, when a content of the Li and a total content of the one or more transition metal elements are denoted respectively by X (mol %) and Y (mol %), the solid electrolyte ceramic satisfies any one of the following relational expressions (1) to (3): (1) 0.01≤Y≤4.00 in the range of 221≤X<227; (2) 0.01≤Y≤6.00 in the range of 227≤X<237; and (3) 0.01≤Y≤8.00 in the range of 237≤X≤250.

### CROSS REFERENCE TO RELATED APPLICATIONS

The present application is a continuation of International application No. PCT/JP2021/042216, filed Nov. 17, 2021, which claims priority to Japanese Patent Application No. 2020-191138, filed Nov. 17, 2020, the entire contents of each of which are incorporated herein by reference.

### FIELD OF THE INVENTION

The present invention relates to a solid electrolyte ceramic and a solid-state battery containing the solid electrolyte ceramic.

### BACKGROUND OF THE INVENTION

In recent years, the demand for batteries has been greatly expanded as power supplies for portable electronic devices such as mobile phones and portable personal computers. The development of, as a battery for use in such an application, a sintered-type solid-state secondary battery (so-called “solid-state battery”) that has a solid electrolyte used as an electrolyte and other constituent elements also composed of solids has been advanced.

The solid-state battery includes a positive electrode layer, a negative electrode layer, and a solid electrolyte layer stacked between the positive electrode layer and the negative electrode layer. In particular, the solid electrolyte layer contains a solid electrolyte ceramic, and is responsible for ion conduction between the positive electrode layer and the negative electrode layer. The solid electrolyte ceramic is required to have a higher ion conductivity and a lower electron conductivity. As such a solid electrolyte ceramic, attempts have been made to use ceramics of sintered garnet-type solid electrolytes substituted with Bi from the viewpoint of higher ion conductivity (for example, Patent Document 1 and Non-Patent Document 1).

In solid-state batteries, solid electrolyte ceramics that are higher in relative density also required from the viewpoint of battery capacity.
Patent Document 1: Japanese Patent Application Laid-Open No. 2015-050071 A
Non-Patent Document 1: Gao et al., Solid-state Ionics, 181 (2010) 1415-1419

### SUMMARY OF THE INVENTION

The inventor of the present invention has found that the following problems are caused in solid-state batteries provided with the use of conventional solid electrolyte ceramics as mentioned above. Specifically, in a conventional solid-state battery provided with the use of a garnet-type solid electrolyte ceramic containing Bi, impurities such as a Li—Bi—O-based compound are likely to be produced at grain boundaries, and the Li—Bi—O-based compound is reduced at the time of operating (that is, at the time of charging and discharging) the solid-state battery, and the electron conductivity is increased. The increased electron conductivity causes the phenomenon of short-circuiting the solid battery and/or causes an increase in leakage current.

The inventor of the present invention has also found that it is effective to contain transition metal elements such as Co from the viewpoint of suppressing the production of the Li—Bi—O-based compound, but have also found that the following new problem is caused. Specifically, when transition metal elements are contained in relatively large amounts, impurities containing a transition metal are produced, such as a Li—La—Co—O-based compound that is different from the Li—Bi—O-based compound, and the impurities containing the transition metal also increase the electron conductivity at the time of operating the solid-state battery.

An object of the present invention is to provide a solid electrolyte ceramic that more sufficiently suppresses an increase in electron conductivity due to a solid-state battery operated and has a higher relative density while having excellent ion conductivity.

Another object of the present invention is to provide a solid electrolyte ceramic that more sufficiently suppresses an increase in electron conductivity due to a solid-state battery operated and has a higher relative density while having excellent ion conductivity, if transition metal elements are contained in relatively large amounts.

The present invention relates to a solid electrolyte ceramic that has a garnet-type crystal structure, including at least Li (lithium), La (lanthanum), and O (oxygen), and further including one or more transition metal elements selected from the group consisting of Co (cobalt), Ni (nickel), Mn (manganese), and Fe (iron),

where the solid electrolyte ceramic has a chemical composition represented by:

A_{α}B_{β}D_{γ}O_{ω} (I)
A represents one or more elements selected from the group consisting of Li (lithium), Ga (gallium), Al (aluminum), Mg (magnesium), Zn (zinc), and Sc (scandium), and includes at least Li (lithium);
B represents one or more elements selected from the group consisting of La (lanthanum), Ca (calcium), Sr (strontium), Ba (barium), and lanthanoid elements, and includes at least La (lanthanum);
D represents one or more elements selected from the group consisting of transition elements capable of six-coordination with oxygen and elements that belong to Groups 12 to 15;

5.0≤α≤8.0;

2.5≤β≤3.5;

1.5≤γ≤2.5; and

11≤ω≤13, and

where a content of the Li and a total content of the one or more transition metal elements are denoted respectively by X (mol %) and Y (mol %), when the content of the B is regarded as 100 mol %, the solid electrolyte ceramic satisfies any one of the following relational expressions (1) to (3):

0.01≤Y≤4.00 in a range of 221≤X<227; (1)

0.01≤Y≤6.00 in a range of 227≤X<237; and (2)

0.01≤Y≤8.00 in a range of 237≤X≤250, (3)

The solid electrolyte ceramic according to the present invention more sufficiently suppresses an increase in electron conductivity due to a solid-state battery operated, while having excellent ion conductivity.

The solid electrolyte ceramic according to the present invention also has a higher relative density.

### DETAILED DESCRIPTION OF THE INVENTION

[Solid Electrolyte Ceramic]

The solid electrolyte ceramic material according to the present invention includes a sintered body that has solid electrolyte particles sintered. The solid electrolyte ceramic according to the present invention is a solid electrolyte ceramic that contains at least Li (lithium), La (lanthanum), and O (oxygen) and has a garnet-type crystal structure, and further contains one or more transition metal elements (hereinafter, which may be simply referred to as a “predetermined transition metal element”) selected from the group consisting of Co (cobalt), Ni (nickel), Mn (manganese), and Fe (iron). Furthermore, the solid electrolyte ceramic according to the present invention is a ceramic including a solid electrolyte that has a garnet-type crystal structure, and may contain other composite oxides or single oxides to the extent that the effect of the present invention is not impaired. From the viewpoint of better ion conductivity, Bi (bismuth) is preferably contained. In addition, at least the sintered grains included in the solid electrolyte ceramic as a main component for the present invention have only to have a garnet-type crystal structure.

The solid electrolyte ceramic according to the present invention preferably further contains a predetermined transition metal element while having a chemical composition represented by the following formula (I):

A_{α}B_{β}D_{γ}O_{ω} (I)

In the formula (I), A is one or more elements selected from the group consisting of gallium (Ga), aluminum (Al), magnesium (Mg), zinc (Zn), and scandium (Sc), where the elements include at least Li.

B is one or more elements selected from the group consisting of calcium (Ca), strontium (Sr), barium (Ba), and lanthanoid elements, where the elements include at least La. Examples of the lanthanoid elements include Ce (cerium), Pr (praseodymium), Nd (neodymium), Pm (promethium), Sm (samarium), Eu (europium), Gd (gadolinium), Tb (terbium), Dy (dysprosium), Ho (holmium), Er (erbium), Tm (thulium), Yb (ytterbium), and Lu (lutetium).

D represents one or more elements selected from the group consisting of transition elements capable of six-coordination with oxygen and typical elements that belong to Groups 12 to 15. Examples of the transition elements capable of six-coordination with oxygen include Sc (scandium), Zr (zirconium), Ti (titanium), Ta (tantalum), Nb (niobium), Hf (hafnium), Mo (molybdenum), W (tungsten), and Te (tellurium). Examples of the typical elements that belong to Groups 12 to 15 include In (indium), Ge (germanium), Sn (tin), Pb (lead), Sb (antimony), and Bi (bismuth). D preferably contains at least Bi from the viewpoint of better ion conductivity.

In the formula (I), α, β, γ, and co respectively satisfy 5.0≤α≤8.0, 2.5≤β≤3.5, 1.5≤γ≤2.5, and 11≤ω≤13.

a preferably satisfies 6.5≤α≤8.0, more preferably 6.65≤α≤7.5, still more preferably 6.65≤α≤7.0, particularly preferably 6.65≤α≤6.75, from the viewpoints of better ion conductivity and more sufficient suppression of an increase in electron conductivity in operation.

β preferably satisfies 2.5≤β≤3.3, more preferably 2.5≤β≤3.1, still more preferably 2.8≤β≤3.0, from the viewpoints of better ion conductivity and more sufficient suppression of an increase in electron conductivity in operation.

γ satisfies preferably 1.8≤γ≤2.5, more preferably 1.8≤γ≤2.3, still more preferably 1.9≤γ≤2.3, from the viewpoints of better ion conductivity and more sufficient suppression of an increase in electron conductivity in operation.

co preferably satisfies 11≤ω≤12.5, more preferably satisfies 11.5≤ω≤12.5, from the viewpoints of better ion conductivity and more sufficient suppression of an increase in electron conductivity in operation.

According to the present invention, the solid electrolyte ceramic contains a relatively large amount of Li within a specific range, thereby more sufficiently suppressing an increase in electron conductivity while having excellent ion conductivity, if the solid electrolyte ceramic contains relatively large amounts of transition metal elements. In such a solid electrolyte ceramic, the excessively low content of Li fails to sufficiently suppress an increase in electron conductivity. The excessively high content of Li decreases the relative density.

In the present invention, the Li content and the content of the predetermined transition metal element in the solid electrolyte ceramic are specifically as follows. More specifically, when the content of Li and the total content of the predetermined transition metal elements are denoted respectively by X (mol %) and Y (mol %) in the case of regarding, as 100 mol %, the content of B in the formula (I) that represents the chemical composition of the solid electrolyte ceramic according to the present invention, the solid electrolyte ceramic according to the present invention satisfies any one of the following relational expressions (1) to (3):
(1) in the range of 221≤X<227 (particularly 222 X≤226), 0.01≤Y≤4.00 (the composite range of 0.01≤Y<1.40 and 1.40≤Y≤4.00) (from the viewpoints of better ion conductivity, more sufficient suppression of an increase in electron conductivity in operation, and further increase in relative density, preferably 0.01≤Y≤3.50 (the composite range of 0.01≤Y<1.50 and 1.50≤Y≤3.50), more preferably 0.02≤Y≤3.40 (the composite range of 0.02≤Y<1.60 and 1.60≤Y≤3.40));
(2) in the range of 227≤X<237 (particularly 227 X≤235), 0.01≤Y≤6.00 (the composite range of 0.01≤Y<1.40 and 1.40≤Y≤6.00) (from the viewpoints of better ion conductivity, more sufficient suppression of an increase in electron conductivity in operation, and further increase in relative density, preferably 0.01≤Y≤5.50 (the composite range of 0.01≤Y<1.50 and 1.50≤Y≤5.50), more preferably 0.02≤Y≤5.20 (the composite range of 0.02≤Y<1.60 and 1.60≤Y≤5.20)); and
(3) in the range of 237≤X≤250 (particularly 237 X≤245), 0.01≤Y≤8.00 (the composite range of 0.01≤Y<1.40 and 1.40≤Y≤8.00) (from the viewpoints of better ion conductivity, more sufficient suppression of an increase in electron conductivity in operation, and further increase in relative density, preferably 0.01≤Y≤7.50 (the composite range of 0.01≤Y<1.50 and 1.50≤Y≤7.50), more preferably 0.02≤Y≤7.00 (the composite range of 0.02≤Y<1.60 and 1.60≤Y≤7.00)).

In each of the relational expressions (1) to (3), when the total content Y of the predetermined transition metal element is excessively larger than a predetermined value, the increase in electron conductivity fails to be sufficiently suppressed.

The Li content X and the total content Y of the predetermined transition metal element are expressed as a proportion (mol %) in the case of regarding the content of B as 100 mol %, but can also be expressed as a proportion (mol %) in the case of regarding, as 100 mol %, the number of eight-coordination sites of the garnet-type crystal structure. For example, in the case of the chemical composition of the formula (II) described later, the proportion refers to a value that can be expressed as a proportion (mol %) in the case of regarding the total number of La and B¹ as 100 mol %. In other specific examples, the eight-coordination site in the garnet-type crystal structure refers to, for example, a site occupied by La in Li₅La₃Nb₂O₁₂ (ICDD Card No. 00-045-0109) that has a garnet-type crystal structure, and likewise, a site occupied by La in a garnet-type crystal structure Li₇La₃Zr₂O₁₂ (ICDD Card. No 01-078-6708).

The content of Li and the content of the predetermined transition metal element can be measured by performing inductively coupled plasma (ICP: Inductively Coupled Plasma) emission spectrometry (ICP analysis) of the solid electrolyte ceramic and obtaining the average chemical composition of the material. Specifically, based on the ICP analysis, the average chemical composition can be determined, and from the average chemical composition, the content of Li and the contents of Co, Mn, Ni and Fe can be determined as proportions in the case of regarding the content of B in the formula (I) as 100 mol %. For example, the contents can also be determined as proportions in the case of regarding, as 100 mol %, the number of eight-coordination sites (for example, the total number of La and B¹ in the formula (II)) of the garnet-type crystal structure.

It is to be noted that the measurement and calculation may be performed with an X-ray photoelectron spectroscopy (XPS).

The content of Bi (bismuth) is, in the case of regarding the content of B as 100 mol %, typically 33 mol % or less, and from the viewpoints of better ion conductivity, more sufficient suppression of an increase in electron conductivity in operation, and further increase in relative density, preferably more than 0 mol % and 23 mol % or less, more preferably 0.3 mol % to 13 mol %, still more preferably 1 mol % to 12 mol %, particularly preferably 5 mol % to 10 mol %.

The content of Bi can be, as in the case of the content of the predetermined transition metal element, also measured by performing inductively coupled plasma (ICP: Inductively Coupled Plasma) emission spectrometry (ICP analysis) of the solid electrolyte ceramic and obtaining the average chemical composition of the material. Specifically, based on the ICP analysis, the average chemical composition can be determined, and from the average chemical composition, the content of Bi can be determined as a proportion in the case of regarding the content of B in the formula (I) (for example, the total number of La and B¹ in the formula (II) described later) as 100 mol %. It is to be noted that the measurement and calculation may be performed with an X-ray photoelectron spectroscopy (XPS).

The solid electrolyte ceramic according to the present invention preferably satisfies the relational expression (1) or (2) mentioned above, more preferably satisfies the relational expression (1) mentioned above, from the viewpoints of better ion conductivity, more sufficient suppression of an increase in electron conductivity in operation, and further increase in relative density.

The presence form (or contained form) of the predetermined transition metal element in the solid electrolyte ceramic according to the present invention is not particularly limited, and the transition metal element may be present in a crystal lattice or present in a form other than the crystal lattice. For example, the predetermined transition metal element may be present in a bulk, at a grain boundary, or both in the solid electrolyte ceramic. As an example in which the predetermined transition metal element is present in a bulk, the presence in a bulk means that the predetermined transition metal element is present at a metal site (lattice site) constituting a garnet-type crystal structure in the solid electrolyte ceramic according to the present invention. The metal site may be any metal site, and may be, for example, a Li site, a La site, a Bi site, or two or more of these sites. The fact that the predetermined transition metal element is present at a grain boundary means that while the solid electrolyte ceramic according to the present invention is composed of multiple sintered grains, the predetermined transition metal element may be present at the interface between two or more of the sintered grains.

When the solid electrolyte ceramic according to the present invention contains Bi, the presence form (or contained form) of Bi (bismuth) in the solid electrolyte ceramic according to the present invention is not particularly limited, and for example, the predetermined Bi (bismuth) may be present in a bulk, present at a grain boundary, or both in the solid electrolyte ceramic. From the viewpoint of insulation, the Bi is preferably present in a bulk. As an example in which the Bi is present in a bulk, the Bi may be present at a metal site (lattice site) constituting a garnet-type crystal structure in the solid electrolyte ceramic according to the present invention.

In the present invention, the predetermined transition metal and/or Bi (bismuth) may be contained in a ceramic that has a garnet-type crystal structure. Furthermore, the predetermined transition metal and/or Bi (bismuth) may be present as a composite oxide and/or a single oxide containing the predetermined transition metal and/or Bi (bismuth). Further, the oxides may be present at the interfaces between crystal grains of the ceramic that has a garnet-type crystal structure as a main component for the present invention.

The Li (lithium) and La (lanthanum) in the solid electrolyte ceramic according to the present invention may be each typically present in a bulk, and specifically, as an example, present at a Li site and a La site as metal sites (lattice sites) constituting a garnet-type crystal structure in the solid electrolyte ceramic according to the present invention. In this case, some of the Li (lithium) and La (lanthanum) may be each independently present at grain boundaries.

The transition metal element contained in the solid electrolyte ceramic according to the present invention is preferably selected from the group consisting of Co, Ni, and Mn, more preferably selected from the group consisting of Co and Mn, still more preferably contains Co, from the viewpoints of better ion conductivity, more sufficient suppression of an increase in electron conductivity in operation, and further increase in relative density.

In the present invention, the fact that the solid electrolyte ceramic has a garnet-type crystal structure means, in an encompassing manner, that the solid electrolyte ceramic not only simply has a “garnet-type crystal structure”, but also has a “garnet-type similar crystal structure”. Specifically, the solid electrolyte ceramic according to the present invention has a crystal structure that can be identified as a garnet-type or a garnet-type similar crystal structure by those skilled in the field of solid-state batteries in X-ray diffraction. More specifically, the solid electrolyte ceramic according to the present invention may exhibits, in X-ray diffraction, one or more main peaks corresponding to Miller indices that are unique to a so-called garnet-type crystal structure (diffraction pattern: ICDD Card No. 422259) at a predetermined incident angle, or as a garnet-type similar crystal structure, one or more main peaks corresponding to Miller indices that are unique to a so-called garnet-type crystal structure may refer to one or more main peaks that differ in incident angle (that is, peak position or diffraction angle) and intensity ratio (that is, peak intensity or diffraction intensity ratio) due to a difference in composition. Examples of the typical diffraction pattern of the garnet-type similar crystal structure include ICDD Card No. 00-045-0109.

The solid electrolyte ceramic according to the present invention may have, as a specific embodiment, a chemical composition represented by the formula (II). Specifically, the solid electrolyte ceramic may have a chemical composition represented by the formula (II) as a whole. Further, in this case, the solid electrolyte ceramic according to the present invention further contains the predetermined transition metal element as mentioned above while having the chemical composition represented by the formula (II):

(LiₚA¹_{y})(La_{β-z}B¹_{z})(D¹_{γ-x}Biₓ)O_{12-δ} (II)

In the formula (II), A¹ refers to a metal ion that occupies a Li-coordination site in the garnet-type crystal structure. A¹ is an element corresponding to A in the formula (I), and may be one or more elements selected from the group consisting of the elements other than Li among the same elements as the elements exemplified as the A. A¹ is typically one or more elements selected from the group consisting of gallium (Ga), aluminum (Al), magnesium (Mg), zinc (Zn), and scandium (Sc), A¹ is preferably one or more elements selected from the group consisting of Ga (gallium) and Al (aluminum), more preferably two elements of Ga and Al, from the viewpoints of better ion conductivity, more sufficient suppression of an increase in electron conductivity in operation, and further increase in relative density.

In the formula (II), B¹ refers to a metal ion that occupies a La site in the garnet-type crystal structure. B¹ is an element corresponding to B in the formula (I), and may be one or more elements selected from the group consisting of the elements other than La among the same elements as the elements exemplified as the B. B¹ is typically one or more elements selected from the group consisting of calcium (Ca), strontium (Sr), barium (Ba), and lanthanoid elements.

In the formula (II), D¹ refers to a metal element that occupies a six-coordination site (the site occupied by Zr in a garnet-type crystal structure Li₇La₃Zr₂O₁₂ (ICDD Card. No 01-078-6708)) in the garnet-type crystal structure. D¹ is an element corresponding to D in the formula (I), and may be one or more elements selected from the group consisting of the elements other than Bi among the same elements as the elements exemplified as the D. D¹ is typically one or more elements selected from the group consisting of Zr (zirconium), Ta (tantalum), Hf (hafnium), Nb (niobium), Mo (molybdenum), W (tungsten), and Te (tellurium), and from the viewpoints of better ion conductivity, more sufficient suppression of an increase in electron conductivity in operation, and further increase in relative density, preferably contains one or more elements selected from the group consisting of Zr (zirconium) and Ta (tantalum), more preferably contains Zr (zirconium) and Ta (tantalum).

In the formula (II), x satisfies 0≤x≤1.00, and from the viewpoints of better ion conductivity, more sufficient suppression of an increase in electron conductivity in operation, and further increase in relative density, preferably satisfies 0.01≤x≤0.70, more preferably 0.02≤x≤0.40, still more preferably 0.05≤x≤0.40, particularly preferably 0.05≤x≤0.35.

y satisfies 0≤y≤0.50, and from the viewpoints of better ion conductivity, more sufficient suppression of an increase in electron conductivity in operation, and further increase in relative density, preferably satisfies 0≤y≤0.40, more preferably 0≤y≤0.30, still more preferably 0≤y≤0.20, and is particularly preferably 0.

β satisfies 2.5≤β≤3.3, and from the viewpoints of better ion conductivity, more sufficient suppression of an increase in electron conductivity in operation, and further increase in relative density, is preferably 2.5≤β≤3.1, more preferably 2.8≤β≤3.0.

z satisfies 0≤z≤2.00, and from the viewpoints of better ion conductivity, more sufficient suppression of an increase in electron conductivity in operation, and further increase in relative density, is preferably 0≤z≤1.00, more preferably 0≤z≤0.50, still more preferably 0.

γ satisfies 1.5≤γ≤2.5, and from the viewpoints of better ion conductivity, more sufficient suppression of an increase in electron conductivity in operation, and further increase in relative density, preferably satisfies 1.8 Y 2.5, more preferably 1.8≤γ≤2.3, and is still more preferably 1.9≤γ≤2.3.

In the formula (II), p satisfies 5.0≤p≤8.0, and from the viewpoints of better ion conductivity and more sufficient suppression of an increase in electron conductivity in operation, p satisfies 6.5≤p≤8.0, more preferably 6.65≤p≤7.5, still more preferably 6.65<p≤7.0, particularly preferably 6.65≤p≤6.75. It is to be noted that it is difficult to identify the presence form of Li, and a value calculated from the composition of the whole ceramic may be used, which is obtained by using ICP (inductively coupled plasma method) or an XPS analysis.

a is an average valence of A¹. The average valence of A¹ is, for example, a value represented by (n1×a+n2×b+n3×c)/(n1+n2+n3) when A¹ is recognized as n1 elements X with a valence a+, n2 elements Y with a valence b+, and n3 elements Z with a valence c+.

b is an average valence of B¹. The average valence of B¹ is, for example, the same value as the average valence of A¹ mentioned above when B¹ is recognized as n1 elements X with a valence a+, n2 elements Y with a valence b+, and n3 elements Z with a valence c+.

c is an average valence of D¹. The average valence of D¹ is, for example, the same value as the average valence of A¹ mentioned above when D¹ is recognized as n1 elements X with a valence a+, n2 elements Y with a valence b+, and n3 elements Z with a valence c+.

δ represents an oxygen deficiency amount, and may be 0. δ may typically satisfy 0≤δ<1. The quantitative analysis of the oxygen deficiency amount δ is not possible if the latest device is used, and the oxygen deficiency amount δ may be thus considered as being 0.

In the present invention, the average chemical composition of the solid electrolyte ceramic may be the whole ceramic composition determined with the use of ICP (inductively coupled plasma method). In addition, the chemical composition may be measured and calculated with the use of an XPS analysis, or may be determined with the use of TEM-EDX (energy dispersive X-ray spectroscopy) and/or WDX (wavelength dispersive X-ray spectroscopy). Furthermore, the chemical composition may be obtained by performing a quantitative analysis (composition analysis) at random 100 points for each of random 100 sintered grains and calculating the average value thereof.

The content [for example, the molar ratio in the case of regarding the content of B in the formula (I) (or the total number of La and B¹ in the formula (II)) as 100 mol %] of the predetermined transition metal element (that is, Co, Ni, Mn, and Fe) in the solid electrolyte ceramic according to the present invention may be calculated by the following method. In the present invention, the chemical composition of the solid electrolyte ceramic can be determined by an ICP analysis (inductively coupled plasma method), an LA-ICP-MS (laser ablation ICP mass spectrometry) analysis, or the like. In addition, the chemical composition may be measured and calculated with the use of an XPS analysis, or with the use of TEM-EDX (energy dispersive X-ray spectroscopy) or WDX (wavelength dispersive X-ray spectroscopy). Furthermore, the chemical composition may be obtained by performing a quantitative analysis (composition analysis) at random 100 points for each of random 100 sintered grains and calculating the average value thereof.

For example, the analysis by EDX or WDX measures a cross section of the solid-state battery. The cross section of the solid-state battery is a cross section parallel to the direction of stacking the positive electrode layer, the solid electrolyte layer, and the negative electrode layer. The cross section of the solid-state battery can be exposed by polishing after embedding the solid-state battery in a resin. The method for polishing the cross section is not particularly limited, but the solid electrolyte layer can be exposed by cutting with a dicer or the like and then polishing with the use of polishing paper, chemical mechanical polishing, ion milling, or the like. The exposed cross section (solid electrolyte layer) is subjected to quantitative analysis by EDX or WDX (wavelength dispersive X-ray fluorescence analyzer), thereby allowing the molar ratios of Co, Ni, Mn, and Fe to B to be calculated.

In addition, for example, in a TEM-EELS measurement, the electrode layer or solid electrolyte layer of the solid-state battery is made into a flake with the use of a focused ion beam (FIB) or the like, and then, the solid electrolyte site is subjected to the TEM-EELS (Transmission Microscope-Electron Energy-Loss Spectroscopy: Electron Energy-Loss Spectroscopy) measurement. Thus, the elements, Co, Ni, Mn, and Fe included in B in the formula (I) can be detected, and the molar ratios of Co, Ni, Mn, and Fe to the content of B can be calculated.

Specific examples of the chemical composition that represents the solid electrolyte ceramic according to the present invention include the following chemical compositions. It is to be noted that in the chemical compositions listed below, the transition metal elements after the hyphens (-) indicate that the transition metal elements may be present in bulks and/or at grain boundaries as mentioned above.

Li_{6.7}La₃Zr_{1.3}Ta_{0.4}Bi_{0.24}O₁₂—Co_{0.05}

Li_{6.7}La₃Zr_{1.3}Ta_{0.4}Bi_{0.24}O₁₂—Co_{0.1}

Li_{6.8}La₃Zr_{1.3}Ta_{0.4}Bi_{0.24}O₁₂—Co_{0.05}

Li_{6.8}La₃Zr_{1.3}Ta_{0.4}Bi_{0.24}O₁₂—Co_{0.1}

Li_{6.8}La₃Zr_{1.3}Ta_{0.4}Bi_{0.24}O₁₂—Co_{0.15}

Li_{6.9}La₃Zr_{1.3}Ta_{0.4}Bi_{0.24}O₁₂—Co_{0.05}

Li_{6.9}La₃Zr_{1.3}Ta_{0.4}Bi_{0.24}O₁₂—Co_{0.1}

Li_{6.9}La₃Zr_{1.3}Ta_{0.4}Bi_{0.24}O₁₂—Co_{0.15}

Li_{7.1}La₃Zr_{1.3}Ta_{0.4}Bi_{0.24}O₁₂—Co_{0.05}

Li_{7.1}La₃Zr_{1.3}Ta_{0.4}Bi_{0.24}O₁₂—Co_{0.1}

Li_{7.1}La₃Zr_{1.3}Ta_{0.4}Bi_{0.24}O₁₂—Co_{0.15}

Li_{7.1}La₃Zr_{1.3}Ta_{0.4}Bi_{0.24}O₁₂—Co_{0.2}

Li_{7.2}La₃Zr_{1.3}Ta_{0.4}Bi_{0.24}O₁₂—Co_{0.05}

Li_{7.2}La₃Zr_{1.3}Ta_{0.4}Bi_{0.24}O₁₂—Co_{0.1}

Li_{7.2}La₃Zr_{1.3}Ta_{0.4}Bi_{0.24}O₁₂—Co_{0.15}

Li_{7.2}La₃Zr_{1.3}Ta_{0.4}Bi_{0.24}O₁₂—Co_{0.2}

Li_{7.3}La₃Zr_{1.3}Ta_{0.4}Bi_{0.24}O₁₂—Co_{0.05}

Li_{7.3}La₃Zr_{1.3}Ta_{0.4}Bi_{0.24}O₁₂—Co_{0.1}

Li_{7.3}La₃Zr_{1.3}Ta_{0.4}Bi_{0.24}O₁₂—Co_{0.15}

Li_{7.3}La₃Zr_{1.3}Ta_{0.4}Bi_{0.24}O₁₂—Co_{0.2}

The above-mentioned specific examples of the chemical composition contain Co as a transition element, but may contain Ni, Mn, or Fe instead of Co.

[Method for Producing Solid Electrolyte Ceramic]

The solid electrolyte ceramic according to the present invention can be obtained by mixing compounds containing predetermined metal elements (that is, starting materials) with water, drying the mixture, and then heat-treating the dried mixture. The compounds containing the predetermined metal elements may be typically a mixture of compounds containing one metal element selected from the group consisting of Li (lithium), La (lanthanum), and the predetermined transition metal element. Examples of the compounds containing the predetermined metal elements (that is, starting materials) include a lithium hydroxide monohydrate Li₀H·H₂O, a lanthanum hydroxide La(OH)₃, a zirconium oxide ZrO₂, a tantalum oxide Ta₂O₅, a bismuth oxide Bi₂O₃, a cobalt oxide Co₃O₄, a basic nickel carbonate hydrate NiCO₃·2Ni(OH)₂·4H₂O, a manganese carbonate MnCO₃, an iron oxide Fe₂O₃, a lithium nitrate LiNO₃, a lanthanum nitrate hexahydrate La(NO₃)₃·6H₂O, and a bismuth nitrate pentahydrate Bi(NO₃)₃·5H₂O. The mixing ratio of the compound containing the predetermined metal elements may be a ratio such that the solid electrolyte ceramic according to the present invention has a predetermined chemical composition after the heat treatment. The heat treatment temperature is typically 500° C. or higher and 1200° C.; or lower, preferably 600° C.; or higher and 1000° C.; or lower. The heat treatment time is typically 10 minutes or longer and 1440 minutes or shorter, particularly 60 minutes or longer and 600 minutes or shorter.

The solid electrolyte ceramic according to the present invention may contain a sintering aid. As the sintering aid, all sintering aids known in the field of solid-state batteries can be used. The composition of such a sintering aid contains at least lithium (Li), boron (B), and oxygen (O), and the molar ratio of Li to B (Li/B) is preferably 2.0 or more. Specific examples of such a sintering aid include Li₃BO₃, (Li_{2.7}Al_{0.3})BO₃, Li_{2.8}(B_{0.8}C_{0.2})O₃, and LiBO₂.

The content of the sintering aid is typically preferably 0% to 10%, particularly 0% to 5% with respect to the volume ratio of the garnet-type solid electrolyte.

[Solid-State Battery]

The term “solid-state battery” in the present specification refers, in a broad sense to, a battery that has constituent elements (in particular, an e layer) composed of solids, and in a narrow sense, to an “all-solid-state battery” that has constituent elements (in particular, all constituent elements) composed of solids. The “solid-state battery” in the present specification encompasses a so-called “secondary battery” that can be repeatedly charged and discharged and a “primary battery” that can only be discharged. The “solid-state battery” is preferably the “secondary battery”. The “secondary battery” is not excessively limited by its name, and can include, for example, an electrochemical device such as a “power storage device”.

The solid-state battery according to the present invention includes a positive electrode layer, a negative electrode layer, and a solid electrolyte layer, and typically has a stacked structure composed of the positive electrode layer and the negative electrode layer stacked with the solid electrolyte layer interposed therebetween. Each of the positive electrode layer and the negative electrode layer may be stacked to have two or more layers, as long as the solid electrolyte layer is provided therebetween. The solid electrolyte layer in contact with the positive electrode layer and the negative electrode layer is sandwiched therebetween. The positive electrode layer and the solid electrolyte layer may have sintered bodies sintered integrally with each other, and/or the negative electrode layer and the solid electrolyte layer may have sintered bodies sintered integrally with each other. Having sintered bodies sintered integrally with each other means that two or more members (in particular, layers) adjacent to or in contact with each other are joined by sintering. In this regard, the two or more members (in particular, layers) may be integrally sintered while the members are both sintered bodies.

The above-mentioned solid electrolyte ceramic according to the present invention is useful as a solid electrolyte for the solid-state battery. Accordingly, the solid-state battery according to the present invention contains the above-mentioned solid electrolyte ceramic according to the present invention as a solid electrolyte. Specifically, the solid electrolyte ceramic according to the present invention is contained as a solid electrolyte in at least one layer selected from the group consisting of the positive electrode layer, the negative electrode layer, and the solid electrolyte layer. The solid electrolyte ceramic according to the present invention is preferably contained in at least the solid electrolyte layer from the viewpoints of better ion conductivity in the solid electrolyte layer, more sufficient suppression of an increase in electron conductivity in operation, and further increase in relative density.

(Positive Electrode Layer)

In the solid-state battery according to the present invention, the positive electrode layer is not particularly limited. For example, the positive electrode layer contains a positive electrode active material, and may further contain the solid electrolyte ceramic material according to the present invention. The solid electrolyte ceramic according to the present invention is contained in the positive electrode layer, thereby making it possible to keep the solid-state battery from being short-circuited. The positive electrode layer may have the form of a sintered body including positive electrode active material particles. The positive electrode layer may be a layer capable of occluding and releasing ions (in particular, lithium ions).

The positive electrode active material is not particularly limited, and positive electrode active materials known in the field of solid-state batteries can be used. Examples of the positive electrode active material include lithium-containing phosphate compound particles that have a NASICON-type structure, lithium-containing phosphate compound particles that have an olivine-type structure, lithium-containing layered oxide particles, lithium-containing oxide particles that have a spinel-type structure. Specific examples of the preferably used lithium-containing phosphate compounds that have a NASICON-type structure include Li₃V₂(PO₄)₃. Specific examples of the preferably used lithium-containing phosphate compounds that have an olivine-type structure include Li₃Fe₂ (PO₄) 3 and LiMnPO₄. Specific examples of the preferably used lithium-containing layered oxide particles include LiCoO₂ and LiCo_{1/3}Ni_{1/3}Mn_{1/3}O₂. Specific examples of the preferably used lithium-containing oxides that have a spinel-type structure include LiMn₂O₄, LiNi_{0.5}Mn_{1.5}O₄, and Li₄Ti₅O₁₂. From the viewpoint of reactivity at the time of co-sintering with the LISICON-type solid electrolyte used in the present invention, lithium-containing layered oxides such as LiCoO₂ and LiCo_{1/3}Ni_{1/3}Mn_{1/3}O₂ are more preferably used as the positive electrode active material. It is to be noted that only one of these positive electrode active material particles may be used, or two or more thereof may be used in mixture.

The fact that the positive electrode active material has a NASICON-type structure in the positive electrode layer means that the positive electrode active material (in particular, particles thereof has a NASICON-type crystal structure, and in a broad sense, refers to the fact that the negative electrode active material has a crystal structure that can be identified as a NASICON-type crystal structure by those skilled in the field of solid-state batteries. In a narrow sense, the fact that the positive electrode active material has a NASICON-type structure in the positive electrode layer means that the positive electrode active material (in particular, particles thereof) exhibits, at a predetermined incident angle, one or more main peaks corresponding to Miller indices that are unique to a so-called NASICON-type crystal structure in X-ray diffraction. Examples of the preferably used positive electrode active material that has a NASICON-type structure include the compounds exemplified above.

The fact that the positive electrode active material has an olivine-type structure in the positive electrode layer means that the positive electrode active material (in particular, particles thereof) has an olivine-type crystal structure, and in a broad sense, refers to the fact that the negative electrode active material has a crystal structure that can be identified as an olivine-type crystal structure by those skilled in the field of solid-state batteries. In a narrow sense, the fact that the positive electrode active material has an olivine-type structure in the positive electrode layer means that the positive electrode active material (in particular, particles thereof) exhibits, at a predetermined incident angle, one or more main peaks corresponding to Miller indices that are unique to a so-called olivine-type crystal structure in X-ray diffraction. Examples of the preferably used positive electrode active material that has an olivine-type structure include the compounds exemplified above.

The fact that the positive electrode active material has a spinel-type structure in the positive electrode layer means that the positive electrode active material (in particular, particles thereof) has a spinel-type crystal structure, and in a broad sense, refers to the fact that the negative electrode active material has a crystal structure that can be identified as a spinel-type crystal structure by those skilled in the field of solid-state batteries. In a narrow sense, the fact that the positive electrode active material has a spinel-type structure in the positive electrode layer means that the positive electrode active material (in particular, particles thereof) exhibits, at a predetermined incident angle, one or more main peaks corresponding to Miller indices that are unique to a so-called spinel-type crystal structure in X-ray diffraction. Examples of the preferably used positive electrode active material that has a spinel-type structure include the compounds exemplified above.

The chemical composition of the positive electrode active material may be an average chemical composition. The average chemical composition of the positive electrode active material means the average value of the chemical compositions of the positive electrode active material in the thickness direction of the positive electrode layer. The average chemical composition of the positive electrode active material can be analyzed and measured by breaking the solid-state battery and performing a composition analysis in accordance with EDX with the use of SEM-EDX (energy dispersive X-ray spectroscopy) in a field of view in which the positive electrode layer is all included in the thickness direction.

The positive electrode active material can be, for example, produced by the following method, or obtained as a commercially available product. In the case of producing the positive electrode active material, first, a raw material compound containing a predetermined metal atom is weighed so as to provide a predetermined chemical composition, and water is added thereto and mixed therewith to obtain a slurry. Then, the slurry is dried, subjected to calcination at 700° C. or higher and 1000° C.; or lower for 1 hour or longer and 30 hours or shorter, and subjected to grinding, thereby allowing the positive electrode active material to be obtained.

The chemical composition and crystal structure of the positive electrode active material in the positive electrode layer may be typically changed by element diffusion at the time of sintering. The positive electrode active material may have the chemical composition and crystal structure mentioned above in the solid-state battery after being subjected to sintering together with the negative electrode layer and the solid electrolyte layer.

The average particle size of the positive electrode active material is not particularly limited, may be, for example, 0.01 μm to 10 μm, and is preferably 0.05 μm to 4 μm.

For the average particle size of the positive electrode active material, for example, 10 to 100 particles can be randomly selected from an SEM image, and the particle sizes can be simply averaged to determine the average particle size (arithmetic average).

The particle size is regarded as the diameter of a spherical particle when the particle is assumed to be a perfect sphere. For such a particle size, for example, a section of the solid-state battery can be cut out, a sectional SEM image can be photographed with the use of an SEM, the sectional area S of the particle can be then calculated with the use of image analysis software (for example, “Azo-kun” (manufactured by Asahi Kasei Engineering Corporation)), and the particle diameter R can be then determined by the following formula:

R=2×(S/π)^{1/2}

It is to be noted that the average particle size of the positive electrode active material in the positive electrode layer can be automatically measured by specifying the positive electrode active material depending on the composition, at the time of measuring the average chemical composition mentioned above.

The average particle size of the positive electrode active material in the positive electrode layer may be typically changed by sintering in the process of producing the solid-state battery. In the solid-state battery after being subjected to sintering together with the negative electrode layer and the solid electrolyte layer, the positive electrode active material may have the average particle size mentioned above.

The volume percentage of the positive electrode active material in the positive electrode layer is not particularly limited, and may be, for example, 30% to 90%, particularly 40% to 70%.

The positive electrode layer may contain the solid electrolyte ceramic material according to the present invention as a solid electrolyte, and/or may contain a solid electrolyte other than the solid electrolyte ceramic material according to the present invention.

The positive electrode layer may further contain a sintering aid and/or a conductive material.

When the positive electrode layer contains the solid electrolyte ceramic according to the present invention, the volume percentage of the solid electrolyte ceramic material according to the present invention may be typically 20% to 60%, particularly 30% to 45%.

As the sintering aid in the positive electrode layer, the same compound as the sintering aid that may be contained in the solid electrolyte ceramic can be used.

The volume percentage of the sintering aid in the positive electrode layer is not particularly limited, and is, for example, preferably 0.1% to 20%, more preferably 1% to 100.

Conductive materials known in the field of solid-state batteries can be used for the conductive material in the positive electrode layer. Examples of preferably used conductive materials include metal materials such as Ag (silver), Au (gold), Pd (palladium), Pt (platinum), Cu (copper), Sn (tin), and Ni (nickel); and carbon materials such as acetylene black, Ketjen black, and carbon nanotubes such as Super P (registered trademark) and VGCF (registered trademark). The shapes of the carbon materials are not particularly limited, and any shape such as a spherical shape, a plate shape, and a fibrous shape may be used.

The volume percentage of the conductive material in the positive electrode layer is not particularly limited, and is preferably 10% to 50%, more preferably 20% to 40%.

The thickness of the positive electrode layer is typically 0.1 to 30 μm, for example, preferably 1 to 20 μm. For the thickness of the positive electrode layer, the average value of thicknesses measured at arbitrary ten points in an SEM image is used.

In the positive electrode layer, the porosity is not particularly limited, and is preferably 20% or less, more preferably 15% or less, still more preferably 10% or less.

For the porosity of the positive electrode layer, a value measured from an SEM image after FIB sectional processing is used.

The positive electrode layer is a layer, which can be referred to as a “positive electrode active material layer”. The positive electrode layer may have a so-called positive electrode current collector or positive electrode current collecting layer.

(Negative Electrode Layer)

In the solid-state battery according to the present invention, the negative electrode layer is not particularly limited. For example, the negative electrode layer contains a negative electrode active material, and may further contain the solid electrolyte ceramic according to the present invention. The solid electrolyte ceramic according to the present invention is contained in the negative electrode layer, thereby making it possible to keep the solid-state battery from being short-circuited. The negative electrode layer may have the form of a sintered body including negative electrode active material particles. The negative electrode layer may be a layer capable of occluding and releasing ions (in particular, lithium ions).

The negative electrode active material is not particularly limited, and negative electrode active materials known in the field of solid-state batteries can be used. Examples of the negative electrode active material include carbon materials such as graphite, graphite-lithium compounds, lithium metal, lithium alloy particles, phosphate compounds that have a NASICON-type structure, Li-containing oxides that have a spinel-type structure, and oxides that have a β_{II}-Li₃VO₄-type structure or a γ_{II}-Li₃VO₄-type structure. For the negative electrode active material, lithium metal or a Li-containing oxide that has a β_{II}-Li₃VO₄-type structure or a γ_{II}-Li₃VO₄-type structure is preferably used.

The fact that the oxide has a β_{II}-Li₃VO₄-type structure in the negative electrode means that the oxide (in particular, particles thereof) has a β_{II}-Li₃VO₄-type crystal structure, and in a broad sense, refers to the fact that the oxide has a crystal structure that can be identified as a β_{II}-Li₃VO₄-type crystal structure by those skilled in the field of solid-state batteries. In a narrow sense, the fact that the oxide has a β_{II}-Li₃VO₄-type structure in the negative electrode layer means that the oxide (in particular, particles thereof) exhibits, at a predetermined incident angle, one or more main peaks corresponding to Miller indices that are unique to a so-called β_{II}-Li₃VO₄-type crystal structure in X-ray diffraction. Examples of the Li-containing oxide that has a β_{II}-Li₃VO₄-type structure, which is preferably used, include Li₃VO₄.

The fact that the oxide has a γ_{II}-Li₃VO₄-type structure in the negative electrode means that the oxide (in particular, particles thereof) has a γ_{II}-Li₃VO₄-type crystal structure, and in a broad sense, refers to the fact that the oxide has a crystal structure that can be identified as a γ_{II}-Li₃VO₄-type crystal structure by those skilled in the field of solid-state batteries. In a narrow sense, the fact that the oxide has a γ_{II}-Li₃VO₄-type structure in the negative electrode layer means that the oxide (in particular, particles thereof) exhibits, at a predetermined incident angle (x-axis), one or more main peaks corresponding to Miller indices that are unique to a so-called γ_{II}-Li₃VO₄-type crystal structure in X-ray diffraction. Examples of the Li-containing oxide that has a γ_{II}-Li₃VO₄-type structure, which is preferably used, include Li_{3.2}V_{0.8}Si_{0.2}O₄.

The chemical composition of the negative electrode active material may be an average chemical composition. The average chemical composition of the negative electrode active material means the average value of the chemical compositions of the negative electrode active material in the thickness direction of the negative electrode layer. The average chemical composition of the negative electrode active material can be analyzed and measured by breaking the solid-state battery and performing a composition analysis in accordance with EDX with the use of SEM-EDX (energy dispersive X-ray spectroscopy) in a field of view in which the negative electrode layer is all included in the thickness direction.

The negative electrode active material can be, for example, produced by the same method as for the positive electrode active material, or obtained as a commercially available product.

The chemical composition and crystal structure of the negative electrode active material in the negative electrode layer may be typically changed by element diffusion at the time of sintering in the process of producing the solid-state battery. The negative electrode active material may have the average chemical composition and crystal structure mentioned above in the solid-state battery after being subjected to sintering together with the positive electrode layer and the solid electrolyte layer.

The volume percentage of the negative electrode active material in the negative electrode layer is not particularly limited, and is, for example, preferably 50% or more (particularly 50% to 99%), more preferably 70% to 95%, still more preferably 80% to 90%.

The negative electrode layer may contain the solid electrolyte ceramic material according to the present invention as a solid electrolyte, and/or may contain a solid electrolyte other than the solid electrolyte ceramic material according to the present invention.

The negative electrode layer may further contain a sintering aid and/or a conductive material.

When the negative electrode layer contains the solid electrolyte ceramic according to the present invention, the volume percentage of the solid electrolyte ceramic material according to the present invention may be typically 20% to 60%, particularly 30% to 45%.

As the sintering aid in the negative electrode layer, the same compound as the sintering aid in the positive electrode layer can be used.

As the conductive material in the negative electrode layer, the same compound as the conductive material in the positive electrode layer can be used.

The thickness of the negative electrode layer is typically 0.1 to 30 μm, preferably 1 to 20 μm. For the thickness of the negative electrode layer, the average value of thicknesses measured at arbitrary ten points in an SEM image is used.

In the negative electrode layer, the porosity is not particularly limited, and is preferably 20% or less, more preferably 15% or less, still more preferably 10% or less.

For the porosity of the negative electrode layer, a value measured by the same method as for the porosity of the positive electrode layer is used.

The negative electrode layer is a layer, which can be referred to as a “negative electrode active material layer”. The negative electrode layer may have a so-called negative electrode current collector or negative electrode current collecting layer.

(Solid Electrolyte Layer)

In the solid-state battery according to the present invention, the solid electrolyte layer preferably contains the above-mentioned solid electrolyte ceramic according to the present invention, from the viewpoints of better ion conductivity, more sufficient suppression of an increase in electron conductivity in operation, and further increase in relative density.

The volume percentage of the solid electrolyte ceramic according to the present invention in the solid electrolyte layer is not particularly limited, and is preferably 10% to 100%, more preferably 20% to 100%, still more preferably 30% to 100%, from the viewpoints of better ion conductivity, more sufficient suppression of an increase in electron conductivity in operation, and further increase in relative density.

When the solid electrolyte layer contains the solid electrolyte ceramic according to the present invention, the solid electrolyte ceramic according to the present invention with the chemical composition mentioned above has only to be present at least at the central part (in particular, among the arbitrary ten points, five points or more, preferably eight points or more, and more preferably the ten points) in the thickness direction of the solid electrolyte layer. This is because, with the solid electrolyte layer sandwiched between the positive electrode layer and the negative electrode layer, sintering in the process of producing the solid-state battery may cause element diffusion from the positive electrode layer and the negative electrode layer to the solid electrolyte layer and/or element diffusion from the solid electrolyte layer to the positive electrode layer and the negative electrode layer.

In addition to the garnet-type solid electrolyte ceramic according to the present invention, the solid electrolyte layer may contain one or more materials selected from a solid electrolyte composed of at least Li, Zr, and O, a solid electrolyte that has a γ-Li₃VO₄ structure, and an oxide glass ceramic-based lithium ion conductor. Examples of the solid electrolyte composed of at least Li, Zr, and O include Li₂ZrO₃.

Examples of the solid electrolyte that has a γ-Li₃VO₄ structure include a solid electrolyte that has an average chemical composition represented by the following formula (III):

(Li_{[3-ax+(5-c)(1-y)]}Aₓ)(B_{y}D_{1-y})O₄ (III)

In the formula (III), A is one or more elements selected from the group consisting of Na, K, Mg, Ca, Al, Ga, Zn, Fe, Cr, and Co.

B is one or more elements selected from the group consisting of V and P.

D is one or more elements selected from the group consisting of Zn, Al, Ga, Si, Ge, Sn, As, Ti, Mo, W, Fe, Cr, and Co.

x satisfies 0≤x≤1.0, particularly satisfies 0≤x≤0.2.

y satisfies 0≤y≤1.0, particularly satisfies 0.20≤y≤0.50.

a is an average valence of A. The average valence of A is, for example, a value represented by (n1×a+n2×b+n3×c)/(n1+n2+n3) when A is recognized as n1 elements X with a valence a+, n2 elements Y with a valence b+, and n3 elements Z with a valence c+.

c is an average valence of D. The average valence of D is, for example, the same value as the average valence of A mentioned above when D is recognized as n1 elements X with a valence a+, n2 elements Y with a valence b+, and n3 elements Z with a valence c+.

Specific examples of the solid electrolyte that has a γ-Li₃VO₄ structure include Li_{3.2}(V_{0.8}Si_{0.2}) 04, Li_{3.5}(V_{0.5}Ge_{0.5})O₄, Li_{3.4}(P_{0.6}Si_{0.4})O₄, and Li_{3.5}(P_{0.5}Ge_{0.5})O₄.

As the oxide glass ceramic-based lithium ion conductor, for example, a phosphate compound (LATP) containing lithium, aluminum, and titanium as constituent elements, and a phosphate compound (LAGP) containing lithium, aluminum, and germanium as constituent elements can be used.

The solid electrolyte layer may further contain, for example, a sintering aid and the like in addition to the solid electrolytes.

As the sintering aid in the solid electrolyte layer, the same compound as the sintering aid in the positive electrode layer can be used.

The volume percentage of the sintering aid in the solid electrolyte layer is not particularly limited, and is preferably 0% to 20%, more preferably 1% to 10%, from the viewpoints of better ion conductivity, more sufficient suppression of an increase in electron conductivity in operation, and further increase in relative density.

The thickness of the solid electrolyte layer is typically 0.1 to 30 μm, and is preferably 1 to 20 μm from the viewpoints of better ion conductivity, more sufficient suppression of an increase in electron conductivity in operation, and further increase in relative density. For the thickness of the solid electrolyte layer, the average value of thicknesses measured at arbitrary ten points in an SEM image is used.

In the solid electrolyte layer, the porosity is not particularly limited, and is preferably 20% or less, more preferably 15% or less, still more preferably 10% or less from the viewpoints of better ion conductivity, more sufficient suppression of an increase in electron conductivity in operation, and further improvement in relative density.

For the porosity of the solid electrolyte layer, a value measured by the same method as for the porosity of the positive electrode layer is used.

[Method for Producing Solid-State Battery]

The solid-state battery can be produced, for example, by a so-called green sheet method, a printing method, or a combined method thereof.

The green sheet method will be described.

First, a paste is prepared by appropriately mixing a positive electrode active material with a solvent, a binder, and the like. The paste is applied onto a sheet, and dried to form a first green sheet for constituting the positive electrode layer. The first green sheet may contain therein a solid electrolyte, a conductive material, a sintering aid, and/or the like.

A paste is prepared by appropriately mixing a negative electrode active material with a solvent, a binder, and the like. The paste is applied onto a sheet, and dried to form a second green sheet for constituting the negative electrode layer. The second green sheet may contain therein a solid electrolyte, a conductive material, a sintering aid, and/or the like.

A paste is prepared by appropriately mixing a solid electrolyte with a solvent, a resin, and the like. The paste is applied and dried to fabricate a third green sheet for constituting the solid electrolyte layer. The third green sheet may contain therein a sintering aid and the like.

The solvent for fabricating the first to third green sheets is not particularly limited, and for example, a solvent is used, which may be used for the production of a positive electrode layer, a negative electrode layer, or a solid electrolyte layer in the field of solid-state batteries. As the solvent, a solvent capable of using the binder described later is usually used. Examples of such a solvent include alcohols such as 2-propanol.

The binder for fabricating the first to third green sheets is not particularly limited, and for example, a binder is used, which can be used for the production of a positive electrode layer, a negative electrode layer, or a solid electrolyte layer in the field of solid-state batteries. Examples of such a binder include a butyral resin and an acrylic resin.

Next, the first to third green sheets are appropriately stacked to fabricate a stacked body. The stacked body fabricated may be pressed. Preferred examples of the method for pressing include an isostatic pressing method.

Thereafter, the stacked body is subjected to sintering at, for example, 600 to 800° C., thereby allowing a solid-state battery to be obtained.

The printing method will be described.

The printing method is the same as the green sheet method except for the following matters.
Prepared is an ink for each layer that has the same composition as the composition of the paste for each layer for obtaining a green sheet except for the blending amounts of the solvent and resin as blending amounts suitable for use as the ink.
The inks for each layer are used for printing and stacking, thereby fabricating a stacked body.

Hereinafter, the present invention will be described in more detail, based on specific examples, but the present invention is not to be considered limited to the following examples in any way, and can be worked with changes appropriately made without changing the scope of the invention.

### EXAMPLES

### Examples 1 to 24 and Comparative Examples 1 to 7

[Production of Solid Electrolyte Ceramic]

For starting materials, a lithium hydroxide monohydrate LiOH·H₂O, a lanthanum hydroxide La(OH)₃, a zirconium oxide ZrO₂, a tantalum oxide Ta₂O₅, a bismuth oxide Bi₂O₃, a cobalt oxide Co₃O₄, a basic nickel carbonate hydrate NiCO₃·2Ni(OH)₂·4H₂O, a manganese carbonate MnCO₃, and an iron oxide Fe₂O₃ were used.

Each starting material was weighed so as to provide each chemical composition in Table 1.

Water was added thereto, and the mixture was encapsulated in a polyethylene polypot, and rotated on a pot rack at 150 rpm for 16 hours to mix the raw materials.

In addition, lithium hydroxide monohydrate LiOH·H₂O as a Li source was put in an excess of 3% by weight with respect to the target composition in consideration of Li deficiency at the time of sintering.

The obtained slurry was subjected to evaporation and dried, and then subjected to calcination at 900° C.; for 5 hours in O₂ to obtain a target phase.

The calcined powder obtained was, with the addition of a mixed solvent of toluene-acetone thereto, subjected to grinding for 12 hours in a planetary ball mill. This ground powder was confirmed by ICP measurement to have no compositional deviation. The average particle size of the ground powder at the time was 150 nm.

[Production of Solid Electrolyte Single Plate]

As a sample for evaluation of a solid electrolyte ceramic, a solid electrolyte single plate was produced by the following method.

The solid electrolyte powder obtained, a butyral resin, and an alcohol were mixed thoroughly in proportions by weight of 200:15:140, and the alcohol was then removed on a hot plate at 80° C.; to obtain a powder coated with the butyral resin to serve as a binder.

Then, the coated powder was pressed at 90 MPa and then molded into a tablet shape with the use of a tableting machine.

The tablet was adequately coated with a mother powder, subjected to a degreasing treatment under an oxygen atmosphere at a temperature of 500° C.; to remove the butyral resin, and then subjected to sintering under an oxygen atmosphere at about 1200° C.; for 3 hours, and the temperature was lowered to room temperature to obtain a sintered body of the solid electrolyte.

The surface of the sintered body obtained was polished to obtain a garnet solid electrolyte single plate.

[Crystal Structure of Solid Electrolyte Single Plate]

In all of the examples and comparative examples, it was confirmed that X-ray diffraction images attributable to the garnet-type similar crystal structure were obtained from X-ray diffraction at the solid electrolyte single plates (ICDD Card No. 00-045-0109).

[Chemical Composition of Solid Electrolyte Single Plate]

The solid electrolyte single plate was subjected to an ICP analysis to obtain the average chemical composition of the solid electrolyte single plate. The contents of Co, Mn, Ni, and Fe in the average chemical composition of the whole solid electrolyte single plate were determined as proportions in the case of regarding, as 100 mol %, the content of the B (for example, the total number of La and B¹ in the formula (II)) in the garnet-type crystal structure. It is to be noted that a value calculated from the molar ratios and valences of the elements included in A, B, and D in the formula (I) so as to establish charge neutrality is employed for O (oxygen) in the chemical composition.

[Measurement of Electron Conductivity]

Onto one side of the obtained single plate, an Au electrode was sputtered as a working electrode. A Li metal with the same area as the Au electrode was attached to the other side. Finally, the cell was enclosed in a coin cell in a size 2035 to obtain an evaluation cell. The operations mentioned above were all performed in a dry room having a dew point of −40° C.; or lower.

At room temperature, 2 V with respect to Li was applied to the working electrode, and the transient current was observed. The current flowing 10 hours after applying the voltage was read as a leakage current. From the leakage current, the electron conductivity was calculated with the use of the following formula:

Electron Conductivity=(I/V)×(L/A)
(I: leakage current, V: applied voltage, L: solid electrolyte single plate thickness, A: electrode area)
⊙: electron conductivity<1.0×10⁻⁸ S/cm (excellent);
∘; 1.0×10⁻⁸ S/cm≤electron conductivity<5.0×10⁻⁸ S/cm (good);
Δ; 5.0×10⁻⁸ S/cm≤electron conductivity<1.0×10⁻⁷ S/cm (acceptable) (no practical problem); and
x; 1.0×10⁻⁷ S/cm≤electron conductivity (not acceptable) (practical problem).

[Measurement of Ion Conductivity]

Gold (Au) layers to serve as a current collector layers were formed by sputtering on both sides of the solid electrolyte single plate, and the plate with the layers was then sandwiched and fixed by SUS current collectors. The sintered tablet for each solid electrolyte was subjected to alternate-current impedance measurement at room temperature (25° C.) in the range of 10 MHz to 0.1 Hz (±50 mV) to evaluate the ion conductivity.
⊙: 1.3×10⁻³ S/cm≤ion conductivity (excellent);
∘; 1.0×10⁻³ S/cm≤ion conductivity<1.3×10⁻³ S/cm (good);
Δ; 5.0×10⁻⁴ S/cm≤ion conductivity<1.0×10⁻³ S/cm (acceptable) (no practical problem); and
x; ironic conductivity<5.0×10⁻⁴ S/cm (not acceptable) (practical problem).

[Measurement of Relative Density]

The relative density (%) was calculated by dividing the density calculated from the dimensions and weight of the solid electrolyte single plate by the true density (5.3 g/cm³) of the solid electrolyte.)
⊙: 95%≤relative density (excellent);
∘; 93%≤relative density<95% (good);
Δ; 90%≤relative density<93% (acceptable) (no practical problem); and
x; Ionic conductivity<90% (not acceptable) (practical problem).

[Comprehensive Determination]

The results of evaluating the electron conductivity, the ion conductivity, and the relative density were all comprehensively determined.

⊙: The results of evaluating the electron conductivity, the ion conductivity, and the relative density were all considered as ⊙.

∘: Among all the results of evaluating the electron conductivity, the ion conductivity, and the relative density, the lowest evaluation result was ∘.

Δ: Among all the results of evaluating the electron conductivity, the ion conductivity, and the relative density, the lowest evaluation result was A.

x: Among all the results of evaluating the electron conductivity, the ion conductivity, and the relative density, the lowest evaluation result was x

TABLE 1

| | | Li | Co | | | |
|---|---|---|---|---|---|---|
| | | Content | Content | Bi | | |
| | | X | Y | Content | | |
| | | Molar | Molar | Molar | Ion | |
| | Chemical Composition | Ratio | Ratio | Ratio | Conductivity | Determi- |
| | (A_{α}B_{β}D_{γ}O_{ω}) (I) | (mol %)* | (mol %)* | (mol %)* | (S/cm) | nation |
| Comparative | Li6•6La3Zr1•3Ta0•4Bi0•24O12—Co0.5 | 220 | 1.67 | 8.00 | 1.3 × 10⁻³ | ⊙ |
| Example 1 | | | | | | |
| Comparative | Li6•6La3Zr1•3Ta0•4Bi0•24O12—Co0.1 | 220 | 3.33 | 8.00 | 1.2 × 10⁻³ | ◯ |
| Example 2 | | | | | | |
| Example 1 | Li6•7La3Zr1•3Ta0•4Bi0•24O12—Co0.5 | 223 | 1.67 | 8.00 | 1.3 × 10⁻³ | ⊙ |
| Example 2 | Li6•7La3Zr1•3Ta0•4Bi0•24O12—Co0.1 | 223 | 3.33 | 8.00 | 1.3 × 10⁻³ | ⊙ |
| Comparative | Li6•7La3Zr1•3Ta0•4Bi0•24O12—Co0.15 | 223 | 5.00 | 8.00 | 1.1 × 10⁻³ | ◯ |
| Example 3 | | | | | | |
| Example 3 | Li6•8La3Zr1•3Ta0•4Bi0•24O12—Co0.05 | 227 | 1.67 | 8.00 | 1.1 × 10⁻³ | ◯ |
| Example 4 | Li6•8La3Zr1•3Ta0•4Bi0•24O12—Co0.1 | 227 | 3.33 | 8.00 | 1.0 × 10⁻³ | ◯ |
| Example 5 | Li6•8La3Zr1•3Ta0•4Bi0•24O12—Co0.15 | 227 | 5.00 | 8.00 | 1.0 × 10⁻³ | ◯ |
| Example 6 | Li6•9La3Zr1•3Ta0•4Bi0•24O12—Co0.05 | 230 | 1.67 | 8.00 | 1.1 × 10⁻³ | ◯ |
| Example 7 | Li6•9La3Zr1•3Ta0•4Bi0•24O12—Co0.1 | 230 | 3.33 | 8.00 | 1.0 × 10⁻³ | ◯ |
| Example 8 | Li6•9La3Zr1•3Ta0•4Bi0•24O12—Co0.15 | 230 | 5.00 | 8.00 | 1.0 × 10⁻³ | ◯ |
| Comparative | Li6•8La3Zr1•3Ta0•4Bi0•24O12—Co0.2 | 227 | 6.67 | 8.00 | 9.2 × 10⁻⁴ | Δ |
| Example 4 | | | | | | |
| Example 9 | Li7•1La3Zr1•3Ta0•4Bi0•24O12—Co0.05 | 237 | 1.67 | 8.00 | 9.9 × 10⁻⁴ | Δ |
| Example 10 | Li7•1La3Zr1•3Ta0•4Bi0•24O12—Co0.1 | 237 | 3.33 | 8.00 | 9.1 × 10⁻⁴ | Δ |
| Example 11 | Li7•1La3Zr1•3Ta0•4Bi0•24O12—Co0.15 | 237 | 5.00 | 8.00 | 8.9 × 10⁻⁴ | Δ |
| Example 12 | Li7•1La3Zr1•3Ta0•4Bi0•24O12—Co0.2 | 237 | 6.67 | 8.00 | 8.4 × 10⁻⁴ | Δ |
| Example 13 | Li7•2La3Zr1•3Ta0•4Bi0•24O12—Co0.05 | 240 | 1.67 | 8.00 | 9.2 × 10⁻⁴ | Δ |
| Example 14 | Li7•2La3Zr1•3Ta0•4Bi0•24O12—Co0.1 | 240 | 3.33 | 8.00 | 9.0 × 10⁻⁴ | Δ |
| Example 15 | Li7•2La3Zr1•3Ta0•4Bi0•24O12—Co0.15 | 240 | 5.00 | 8.00 | 8.9 × 10⁻⁴ | Δ |
| Example 16 | Li7•2La3Zr1•3Ta0•4Bi0•24O12—Co0.2 | 240 | 6.67 | 8.00 | 8.9 × 10⁻⁴ | Δ |
| Example 17 | Li7•3La3Zr1•3Ta0•4Bi0•24O12—Co0.05 | 243 | 1.67 | 8.00 | 8.7 × 10⁻⁴ | Δ |
| Example 18 | Li7•3La3Zr1•3Ta0•4Bi0•24O12—Co0.1 | 243 | 3.33 | 8.00 | 8.7 × 10⁻⁴ | Δ |
| Example 19 | Li7•3La3Zr1•3Ta0•4Bi0•24O12—Co0.15 | 243 | 5.00 | 8.00 | 8.7 × 10⁻⁴ | Δ |
| Example 20 | Li7•3La3Zr1•3Ta0•4Bi0•24O12—Co0.2 | 243 | 6.67 | 8.00 | 8.6 × 10⁻⁴ | Δ |
| Comparative | Li7•1La3Zr1•3Ta0•4Bi0•24O12—Co0.25 | 237 | 8.33 | 8.00 | 8.1 × 10⁻⁴ | Δ |
| Example 5 | | | | | | |
| Comparative | Li7•3La3Zr1•3Ta0•4Bi0•24O12—Co0.25 | 243 | 8.33 | 8.00 | 8.6 × 10⁻⁴ | Δ |
| Example 6 | | | | | | |
| Comparative | Li7•6La3Zr1•3Ta0•4Bi0•24O12—Co0.05 | 253 | 1.67 | 8.00 | 7.6 × 10⁻⁴ | Δ |
| Example 7 | | | | | | |

*the content in the case of regarding the content of B as 100 mol %

| | | | | | Compre- |
|---|---|---|---|---|---|
| | Electron | | Relative | | hensive |
| | Conductivity | | Density | | Determi- |
| | (S/cm) | Determination | (%) | Determination | nation |
| Comparative | 1.0 × 10⁻⁶ | X | 97 | ⊙ | X |
| Example 1 | | | | | |
| Comparative | 2.2 × 10⁻⁶ | X | 99 | ⊙ | X |
| Example 2 | | | | | |
| Example 1 | 6.5 × 10⁻⁹ | ⊙ | 96 | ⊙ | ⊙ |
| Example 2 | 5.8 × 10⁻¹⁰ | ⊙ | 95 | ⊙ | ⊙ |
| Comparative | 4.8 × 10⁻⁷ | X | 96 | ⊙ | X |
| Example 3 | | | | | |
| Example 3 | 6.0 × 10⁻⁹ | ⊙ | 96 | ⊙ | ◯ |
| Example 4 | 3.3 × 10⁻⁹ | ⊙ | 98 | ⊙ | ◯ |
| Example 5 | 1.2 × 10⁻⁹ | ⊙ | 94 | ◯ | ◯ |
| Example 6 | 6.0 × 10⁻⁹ | ⊙ | 97 | ⊙ | ◯ |
| Example 7 | 4.1 × 10⁻⁹ | ⊙ | 97 | ⊙ | ◯ |
| Example 8 | 1.5 × 10⁻⁹ | ⊙ | 97 | ⊙ | ◯ |
| Comparative | 2.5 × 10⁻⁶ | X | 96 | ⊙ | X |
| Example 4 | | | | | |
| Example 9 | 5.2 × 10⁻⁹ | ⊙ | 94 | ◯ | Δ |
| Example 10 | 2.0 × 10⁻⁹ | ⊙ | 97 | ⊙ | Δ |
| Example 11 | 1.3 × 10⁻⁹ | ⊙ | 93 | ◯ | Δ |
| Example 12 | 7.2 × 10⁻¹⁰ | ⊙ | 93 | ◯ | Δ |
| Example 13 | 6.2 × 10⁻⁹ | ⊙ | 95 | ⊙ | Δ |
| Example 14 | 4.7 × 10⁻⁹ | ⊙ | 94 | ◯ | Δ |
| Example 15 | 1.1 × 10⁻⁹ | ⊙ | 91 | Δ | Δ |
| Example 16 | 9.4 × 10⁻¹⁰ | ⊙ | 91 | Δ | Δ |
| Example 17 | 5.9 × 10⁻⁹ | ⊙ | 92 | Δ | Δ |
| Example 18 | 9.1 × 10⁻¹⁰ | ⊙ | 91 | Δ | Δ |
| Example 19 | 5.4 × 10⁻¹⁰ | ⊙ | 91 | Δ | Δ |
| Example 20 | 7.1 × 10⁻¹¹ | ⊙ | 90 | Δ | Δ |
| Comparative | 4.3 × 10⁻⁶ | X | 97 | ⊙ | X |
| Example 5 | | | | | |
| Comparative | 2.5 × 10⁻⁶ | X | 95 | ⊙ | X |
| Example 6 | | | | | |
| Comparative | 6.6 × 10⁻⁹ | ⊙ | 83 | X | X |
| Example 7 | | | | | |

TABLE 2

| | | Li Content | Co/Mn/Ni | Bi Content | | |
|---|---|---|---|---|---|---|
| | | X Molar | Content Y | Molar | Ion | |
| | Chemical Composition | Ratio | Molar Ratio | Ratio | Conductivity | |
| | (A_{α}B_{β}D_{γ}O_{ω}) (I) | (mol %)* | (mol %)* | (mol %)* | (S/cm) | Determination |
| Example 21 | Li6•7La3Zr1•3Ta0•4Bi0•24O12—Co0.001 | 223 | 0.03 | 8.00 | 1.3 × 10⁻³ | ⊙ |
| Example 22 | Li7•3La3Zr1•3Ta0•4Bi0•24O12—Co0.001 | 243 | 0.03 | 8.00 | 9.0 × 10⁻⁴ | Δ |
| Example 23 | Li6•7La3Zr1•3Ta0•4Bi0•24O12—Mn0.001 | 223 | 0.03 | 8.00 | 1.3 × 10⁻³ | ⊙ |
| Example 24 | Li6•7La3Zr1•3Ta0•4Bi0•24O12—Ni0.001 | 223 | 0.03 | 8.00 | 1.3 × 10⁻³ | ⊙ |

*the content in the case of regarding the content of B as 100 mol %

| | Electron | | Relative | | |
|---|---|---|---|---|---|
| | Conductivity | | Density | | Comprehensive |
| | ( S/cm) | Determination | (%) | Determination | Determination |
| Example 21 | 6.5 × 10⁻⁹ | ⊙ | 95 | ⊙ | ⊙ |
| Example 22 | 6.0 × 10⁻⁹ | ⊙ | 95 | ⊙ | Δ |
| Example 23 | 4.6 × 10⁻⁸ | ◯ | 95 | ⊙ | ◯ |
| Example 24 | 8.1 × 10⁻⁸ | Δ | 95 | ⊙ | Δ |

From the comparison between Comparative Examples 1 and 2 and Examples 1 to 2, it is clear that when the Li content is less than 221 mol %, the increased electron conductivity increases risk of being short-circuited.

From the comparison between Examples 1 to 2 and Comparative Example 3, it is clear that with the Li content within the range of 221 mol % to less than 227 mol %, the increased electron conductivity increases risk of being short-circuited, when the content of the predetermined transition metal element (particularly, Co) is more than 4 mol %.

From the comparison between Examples 3 to 8 and Comparative Example 4, it is clear that with the Li content within the range of 227 mol % to less than 235 mol %, the increased electron conductivity increases risk of being short-circuited, when the content of the predetermined transition metal element (particularly, Co) is more than 6 mol %.

From the comparison between Examples 9 to 20 and Comparative Examples 5 and 6, it is clear that with the Li content within the range of 235 mol % to 250 mol %, the increased electron conductivity increases risk of being short-circuited, when the content of the predetermined transition metal element (particularly, Co) is more than 8%.

From the comparison between Examples 9 to 20 and Comparative Example 7, it is clear that when the Li content is more than 250 mol %, the deteriorated sinterability decreases the relative density.

The solid-state battery including the solid electrolyte ceramic according to the present invention can be used in various fields where battery use or power storage is assumed. By way of example only, the solid-state battery according to an embodiment of the present invention can be used in the field of electronics mounting. The solid-state battery according to an embodiment of the present invention can also be used in the fields of electricity, information, and communication in which mobile devices and the like are used (for example, electric and electronic equipment fields or mobile equipment fields including mobile phones, smartphones, smartwatches, notebook computers, and small electronic machines such as digital cameras, activity meters, arm computers, electronic papers, wearable devices, RFID tags, card-type electronic money, and smartwatches), home and small industrial applications (for example, the fields of electric tools, golf carts, and home, nursing, and industrial robots), large industrial applications (for example, the fields of forklift, elevator, and harbor crane), transportation system fields (for example, the fields of hybrid vehicles, electric vehicles, buses, trains, power-assisted bicycles, electric two-wheeled vehicles, and the like), power system applications (for example, fields such as various types of power generation, road conditioners, smart grids, and household power storage systems), medical applications (medical device fields such as hearing aid buds), pharmaceutical applications (fields such as dosage management systems), IoT fields, space and deep sea applications (for example, fields such as space probes and submersibles), and the like.

1. A solid electrolyte ceramic having a garnet-type crystal structure, the solid electrolyte ceramic comprising:
at least Li, La, and O; and
one or more transition metal elements selected from the group consisting of Co, Ni, Mn, and Fe, wherein
the solid electrolyte ceramic has a chemical composition represented by:
A_{α}B_{β}D_{γ}O_{ω} (I)
A represents one or more elements selected from the group consisting of the Li, Ga, Al, Mg, Zn, and Sc, and comprises at least the Li;
B represents one or more elements selected from the group consisting of the La, Ca, Sr, Ba, and lanthanoid elements, and comprises at least the La;
D represents one or more elements selected from the group consisting of transition elements capable of six-coordination with oxygen and elements that belong to Groups 12 to 15;
5.0≤α≤8.0;
2.5≤β≤3.5;
1.5≤γ≤2.5; and
11≤ω≤13,
wherein, where a content of the Li and a total content of the one or more transition metal elements are denoted respectively by X (mol %) and Y (mol %), and when a content of the B is regarded as 100 mol %, the solid electrolyte ceramic satisfies any one of relational expressions (1) to (3):
0.01≤Y≤4.00 in a range of 221≤X<227; (1)
0.01≤Y≤6.00 in a range of 227≤X<237; and (2)
0.01≤Y≤8.00 in a range of 237≤X≤250, (3)

2. The solid electrolyte ceramic according to claim 1, wherein:
6.5≤α≤8.0;
2.5≤β≤3.3;
1.8≤γ≤2.5; and
11≤ω≤12.5.

3. The solid electrolyte ceramic according to claim 1, wherein the solid electrolyte ceramic further comprises Bi.

4. The solid electrolyte ceramic according to claim 3, wherein, when the content of the B is regarded as 100 mol %, a content of the Bi is 33 mol % or less.

5. The solid electrolyte ceramic according to claim 1, wherein the solid electrolyte ceramic satisfies the relational expressions (1) or (2).

6. The solid electrolyte ceramic according to claim 1, wherein the solid electrolyte ceramic satisfies the relational expression (1).

7. The solid electrolyte ceramic according to claim 1, wherein the one or more transition metal elements include Co.

8. The solid electrolyte ceramic according to claim 1, wherein the chemical composition of the solid electrolyte ceramic is one of:
Li_{6.7}La₃Zr_{1.3}Ta_{0.4}Bi_{0.24}O₁₂—Co_{0.05},
Li_{6.7}La₃Zr_{1.3}Ta_{0.4}Bi_{0.24}O₁₂—Co_{0.1},
Li_{6.8}La₃Zr_{1.3}Ta_{0.4}Bi_{0.24}O₁₂—Co_{0.05},
Li_{6.8}La₃Zr_{1.3}Ta_{0.4}Bi_{0.24}O₁₂—Co_{0.1}
Li_{6.8}La₃Zr_{1.3}Ta_{0.4}Bi_{0.24}O₁₂—Co_{0.15},
Li_{6.9}La₃Zr_{1.3}Ta_{0.4}Bi_{0.24}O₁₂—Co_{0.05},
Li_{6.9}La₃Zr_{1.3}Ta_{0.4}Bi_{0.24}O₁₂—Co_{0.1},
Li_{6.9}La₃Zr_{1.3}Ta_{0.4}Bi_{0.24}O₁₂—Co_{0.15},
Li_{7.1}La₃Zr_{1.3}Ta_{0.4}Bi_{0.24}O₁₂—Co_{0.05},
Li_{7.1}La₃Zr_{1.3}Ta_{0.4}Bi_{0.24}O₁₂—Co_{0.1},
Li_{7.1}La₃Zr_{1.3}Ta_{0.4}Bi_{0.24}O₁₂—Co_{0.15},
Li_{7.1}La₃Zr_{1.3}Ta_{0.4}Bi_{0.24}O₁₂—Co_{0.2},
Li_{7.2}La₃Zr_{1.3}Ta_{0.4}Bi_{0.24}O₁₂—Co_{0.05},
Li_{7.2}La₃Zr_{1.3}Ta_{0.4}Bi_{0.24}O₁₂—Co_{0.1},
Li_{7.2}La₃Zr_{1.3}Ta_{0.4}Bi_{0.24}O₁₂—Co_{0.15},
Li_{7.2}La₃Zr_{1.3}Ta_{0.4}Bi_{0.24}O₁₂—Co_{0.2},
Li_{7.3}La₃Zr_{1.3}Ta_{0.4}Bi_{0.24}O₁₂—Co_{0.05},
Li_{7.3}La₃Zr_{1.3}Ta_{0.4}Bi_{0.24}O₁₂—Co_{0.1},
Li_{7.3}La₃Zr_{1.3}Ta_{0.4}Bi_{0.24}O₁₂—Co_{0.15}, and
Li_{7.3}La₃Zr_{1.3}Ta_{0.4}Bi_{0.24}O₁₂—Co_{0.2}.

9. A solid-state battery comprising the solid electrolyte ceramic according to claim 1.

10. The solid-state battery according to claim 9, wherein the solid-state battery comprises a positive electrode layer, a negative electrode layer, and a solid electrolyte layer stacked between the positive electrode layer and the negative electrode layer, and
the positive electrode layer and the negative electrode layer are layers capable of occluding and releasing lithium ions.

11. The solid-state battery according to claim 10, wherein the solid electrolyte layer, the positive electrode layer and the negative electrode layer are integrally sintered bodies.

12. The solid-state battery according to claim 9, wherein the solid electrolyte ceramic is contained in the solid electrolyte layer of the solid-state battery.
